(19) United States
(12) Patent Application Publication
(10) Pub. No.: US 2024/0233163 A1
(43) Pub. Date: Jul. 11, 2024

(54) IMAGE COMPARISON DEVICE

(71) Applicant: TOYOTA JIDOSHA KABUSHIKI KAISHA, Toyota-shi (JP)

(72) Inventors: Hiroyasu YAMASHITA, Toyota-shi (JP); Satoshi MIYAKE, Toyota-shi (JP); Harufumi MUTO, Miyoshi-shi (JP)

(21) Appl. No.: 18/395,757

(22) Filed: Dec. 26, 2023

(30) Foreign Application Priority Data
Jan. 10, 2023 (JP) 2023-001694

(51) Int. Cl. G06T 7/62; G06T 3/40; G06T 7/00; G06T 7/73; G06T 11/60

(52) U.S. Cl. CPC G06T 7/62; G06T 3/40; G06T 7/74; G06T 7/97; G06T 11/60; G06T 2207/10004

(57) ABSTRACT

An image comparison device is configured to obtain a first image and a second image, identify multiple first objects and second objects respectively in the first image and the second image, calculate, for each of the first objects, a first specific length that is a length in a predetermined specific direction, calculate, for each of the second objects, a second specific length that is a length in the specific direction, calculate values of a specific variable for all combinations of the first specific lengths and the second specific lengths, each value of the specific variable indicating a ratio between one of the first specific lengths and one of the second specific lengths, and output a most frequently occurring value among the values of the specific variable as a value indicating a scaling ratio of the second image to the first image.

### BACKGROUND

### 1. Field

The present disclosure relates to an image comparison device.

### 2. Description of Related Art

Japanese Laid-Open Patent Publication No. 2005-182323 discloses a technique in which two communication terminals transmit and receive image data to and from each other. A first communication terminal displays an image received from the second communication terminal on a display screen in response to a user operation. At this time, the first communication terminal scales the image in accordance with the size of the display screen.

As in the technique disclosed in the above-described publication, if the image processing performed by the first communication terminal is only to scale an image in accordance with the size of the display screen of the first communication terminal, it is relatively easy to recognize that the processed image is derived from the original image transmitted from the second communication terminal. However, the image processing performed by the first communication terminal may include, for example, adding another image in addition to the scaling of the image. In this case, it is difficult to recognize that the processed image is derived from the original image transmitted from the second communication terminal.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, an image comparison device includes processing circuitry. The processing circuitry being configured to obtain a first image, obtain a second image, the second image being different from the first image, identify multiple first objects in the first image, identify multiple second objects in the second image, calculate a first specific length for each of the first objects, the first specific length being a length in a predetermined specific direction, calculate a second specific length for each of the second objects, the second specific length being a length in the specific direction, calculate values of a specific variable for all combinations of the first specific lengths and the second specific lengths, each value of the specific variable indicating a ratio between one of the first specific lengths and one of the second specific lengths, and output a most frequently occurring value among the values of the specific variable as a value indicating a scaling ratio of the second image to the first image.

Other features and aspects will be apparent from the following detailed description, the drawings, and the claims.

### BRIEF DESCRIPTION OF THE DRAWINGS

FIG. 1 is a schematic diagram showing a configuration of an image comparison device.

FIG. 2 is a diagram showing an example of a first image to be compared in an image comparison process executed by the image comparison device shown in FIG. 1.

FIG. 3 is a diagram showing an example of a second image to be compared in the image comparison process executed by the image comparison device shown in FIG. 1.

FIG. 4 is a diagram for explaining deduplication of duplicate lengths executed by the image comparison device shown in FIG. 1.

FIG. 5 is a flowchart showing a procedure of the image comparison process executed by the image comparison device shown in FIG. 1.

FIG. 6 is a diagram showing examples of vertical index values for various combinations of multiple first specific lengths and multiple second specific lengths calculated in the image comparison process shown in FIG. 5.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, except for operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

Hereinafter, an embodiment of an image comparison device will be described with reference to the drawings.

### Overall Configuration

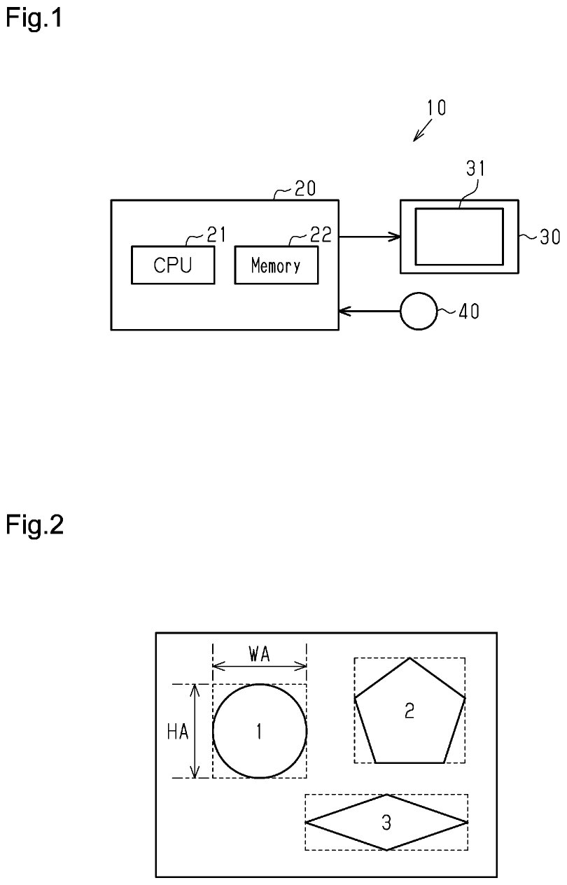

As shown in FIG. 1, the image comparison device 10 includes a control module 20, a display device 30, and an input device 40. The control module 20 is processing circuitry having a central processing unit (CPU 21). The control module 20 includes a group of various storage devices such as a RAM, a ROM, and an electrically rewritable nonvolatile memory. Hereinafter, a group of various storage devices will be simply referred to as a memory 22. The memory 22 stores various programs and various data necessary for executing the programs. The control module 20 includes a communication circuit for communicating with the outside via an external communication network.

The display device 30 is, for example, a liquid crystal display. The display device 30 includes a drive circuit and a display screen 31. The display device 30 is connected to the control module 20 in a wired or wireless manner. The display device 30 displays an image corresponding to display information output by the CPU 21 of the control module 20 on the display screen 31.

The input device 40 is connected to the control module 20 in a wired or wireless manner. The input device 40 is operated by a user to input information from the outside to the control module 20. The input device 40 is, for example, a keyboard and a mouse.

The CPU 21 of the control module 20 can execute an image comparison process. The image comparison process is a process for comparing two images. The memory 22 of the control module 20 stores in advance images to be compared in the image comparison process. The image is downloaded from an external source, for example. The image is intended for insertion into a legal document, for example.

### Images

Images to be compared in the image comparison process will be described. The image is two dimensional data having predetermined vertical and horizontal sizes. That is, the image is formed of a matrix of a plurality of pixels arranged in rows and columns, and has a rectangular shape as a whole. In the present embodiment, an orthogonal coordinate system having two axes corresponding to the vertical and horizontal directions of an image as coordinate axes is referred to as an image coordinate system. The image includes information related to the vertical and horizontal directions as supplementary information. Based on the additional information, the CPU 21 grasps the image coordinate system in the image comparison process.

An example of two images to be compared in the image comparison process will be described. As a premise, each image includes an object. An object is a collection of pixels representing a particular object, such as a figure, symbol, character, or even an object. For example, a single object may be composed of a group of contiguous pixels. For example, a single object may consist of a group of pixels having a common characteristic, such as the same color. In addition, the characteristics of the object are not limited to those exemplified here. Hereinafter, when the object included in the first image and the object included in the second image are individually described, they are distinguished as a first object and a second object, respectively.

As shown in FIG. 2, the first image includes a plurality of first objects. In the example shown in FIG. 2, the first image includes three first objects 1 to 3.

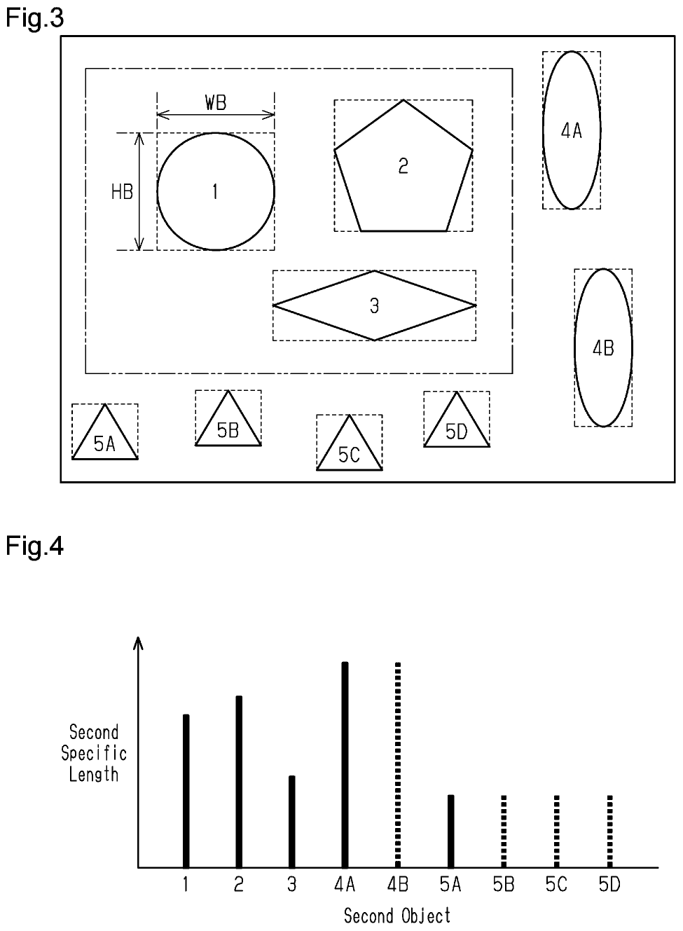

As shown in FIG. 3, the second image is an image different from the first image. The second image includes a plurality of second objects. The second image is obtained by enlarging the first image and adding a new object thereto. That is, some of the plurality of second objects are objects obtained by enlarging the first object. In the example of FIG. 3, the three second objects 1 to 3 are obtained by enlarging the three first objects 1 to 3. Some of the plurality of second objects are newly added objects. In the example of FIG. 3, there are two types of additional objects. The additional objects of the same type have the same shape and size. In the example of FIG. 3, there are two additional objects of the first type, 4A and 4B. In the example of FIG. 3, there are four additional objects of the second type: 5A to 5D. The shape and size of each additional object are different from the shapes and sizes of the three second objects 1 to 3.

### Details of Image Comparison Process

The CPU 21 executes each process of the image comparison process by executing the program stored in the memory 22. Although not described one by one, the CPU 21 causes the memory 22 to appropriately store the date calculated in the course of executing the image comparison process.

The CPU 21 receives the required information input by the user prior to starting the image comparison process. The necessary information includes information for identifying two images designated by the user as comparison targets. In the present embodiment, for example, it is assumed that the first image shown in FIG. 2 and the second image shown in FIG. 3 are designated as comparison targets.

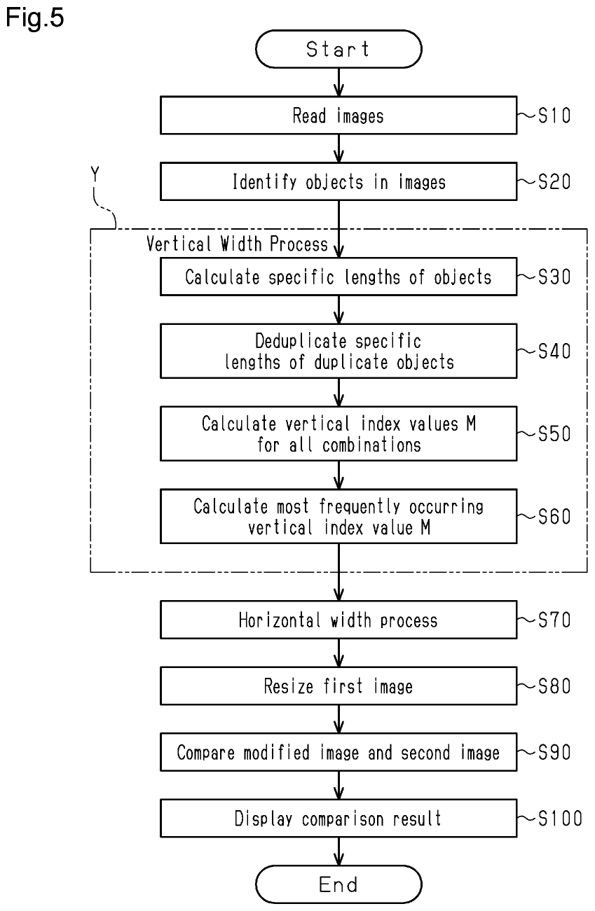

The CPU 21 starts the image comparison process in response to a user's operation. As shown in FIG. 5, when the image comparison process is started, the CPU 21 first performs the processing of step S10. In step S10, the CPU 21 reads the first image stored in the memory 22. That is, the CPU 21 acquires the first image from the memory 22. Further, the CPU 21 reads the second image stored in the memory 22. That is, the CPU 21 acquires the second image from the memory 22. Thereafter, the CPU 21 advances the process to step S20.

In step S20, the CPU 21 identifies all the first objects existing in the first image from the first image. In addition, the CPU 21 identifies all the second objects existing in the second image from the second image. Hereinafter, how to specify the object will be described in detail. The CPU 21 uses the image coordinate system as a reference when identifying an object from each image. When identifying one object, the CPU 21 sets a detection frame for the object to be detected. The detection frame may be referred to as a bounding box. The detection frame is a minimum rectangular frame that includes the entire object to be detected. In FIGS. 2 and 3, the detection frame is indicated by a dotted line. Setting a detection frame substantially means calculating, for example, the coordinate values of vertices in the detection frame. Two orthogonal sides of the detection frame are positioned so as to be along the X-axis and the Y axis of the image coordinate system. The CPU 21 sets the detection frame by using a known image recognition method. For example, the CPU 21 may set the detection frame using a learned model that has been machine-learned in advance. The CPU 21 may specify an object by template matching with various sample images and then set a detection frame surrounding the detected object. Whatever method is used, the CPU 21 applies the same method to both the first image and the second image to set the detection frame. In the present embodiment, setting a detection frame for an object to be detected corresponds to identifying the object. That is, the CPU 21 identifies a region in which an object to be detected is present. Hereinafter, identifying a region in which an object is present is simply referred to as identifying an object. When all objects are identified for each of the first image and the second image, the CPU 21 advances the process to step S30.

In step S30, the CPU 21 calculates a first specific length for each first object identified in step S20. The first specific length is a length in a predetermined specific direction. The specific direction is a direction in which the X-axis extends in the image coordinate system. That is, as shown in FIG. 2, the CPU 21 calculates a vertical width HA of the detection frame of the target first object as the first specific length. Further, in step S30, the CPU 21 calculates a second specific length for each second object identified in step S20. As in the case of the first specific length, the second specific length is a length in the specific direction. The specific direction in this case is a direction in which the X-axis extends in the image coordinate system of the second image. That is, as shown in FIG. 3, the CPU 21 calculates a vertical width HB of the detection frame of the target second object as the second specific length. As shown in FIG. 5, when the CPU 21 calculates the first specific length for all the first objects and the second specific length for all the second objects, the CPU 21 advances the process to step S40.

In step S40, the CPU 21 performs preprocessing before performing the process of step S50 on the second specific lengths calculated in step S30. Among the second objects, those having the same second specific length are referred to as duplicate objects. In the preprocessing, when there are multiple duplicate objects having the same second specific length, the CPU 21 retains one of the second specific lengths of the duplicate objects stored in the memory 22 and deletes the others from the memory 22. FIG. 4 shows the second specific lengths for the second objects in the second image shown in FIG. 3. As shown in FIG. 4, in the second image, the second specific lengths of 4A and 4B, which are the first type additional objects, are the same. In this case, the CPU 21 identifies these two additional objects 4A and 4B as duplicate objects. The CPU 21 retains the second specific length of 4A and deletes the second specific length of 4B among the second specific lengths of the two duplicate objects 4A and 4B stored in the memory 22. In this manner, the CPU 21 deduplicates the second specific lengths of the two duplicate objects 4A and 4B stored in the memory 22. As shown in FIG. 4, in the second image shown in FIG. 3, the second specific lengths of the second additional objects 5A to 5D are the same. In this case, the CPU 21 identifies the four additional objects 5A to 5D as duplicate objects. The CPU 21 retains the second specific length of 5A among the second specific lengths of the four duplicate objects 5A to 5D stored in the memory 22, while deleting the second specific lengths of three duplicate objects 5B to 5D. As a result of this process, the CPU 21 causes the memory 22 to store five second specific lengths of the second objects 1, 2, 3, 4A, and 5A among multiple second specific lengths calculated in step S30. As shown in FIG. 5, when the CPU 21 deduplicates the second specific lengths of the duplicate objects, the CPU 21 advances the process to step S50. Regarding the process of step S40, if there are no duplicate objects, the CPU 21 advances the process directly to step S50.

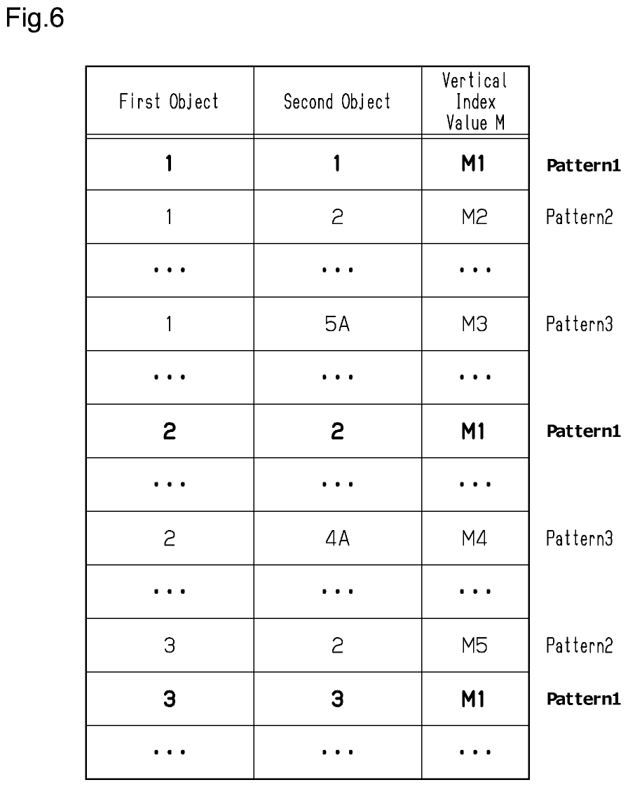

In step S50, the CPU 21 calculates the value of the first specific variable for all combinations of the first specific lengths and the second specific lengths stored in the memory 22. The first specific variable is obtained by dividing one second specific length by one first specific length. The first specific variable is a variable indicating the ratio between one first specific length and one second specific length. Hereinafter, the value of the first specific variable is referred to as a vertical index value M. As shown in FIG. 6, the CPU 21 sequentially calculates the vertical index values M for all combinations of the first specific lengths and the second specific lengths. The leftmost column in FIG. 6 shows identification values of the first objects to be combined. The central column in FIG. 6 shows identification values of the second objects to be combined. As shown in FIG. 5, when the CPU 21 calculates the vertical index values M for all combinations, the CPU 21 advances the process to step S60.

In step S60, the CPU 21 calculates the most frequently occurring value among the vertical index values M calculated in step S50 as a vertical mode MQ. The vertical mode MQ is a value indicating a scaling ratio for the vertical width of the second image to the first image. Upon calculating the vertical mode MQ, the CPU 21 advances the process to step S70. The vertical index values M calculated in step S50 may all be different values. In this case, the CPU 21 cancels the calculation of the vertical mode MQ. Then, in step S60, the CPU 21 causes the display device 30 to display that the second image does not have an object obtained by scaling the first image. In this case, the CPU 21 ends the series of processes of the image comparison process. The above-described processes in steps S30 to S60 correspond to a vertical width process Y for calculating the scaling ratio for the vertical width of the second image to the first image.

When the process proceeds to step S70, the CPU 21 performs a process for horizontal width. In the horizontal width processing, the same processing as that in steps S30 to S60 described above is performed for the horizontal width of each image. Hereinafter, the horizontal width processing will be briefly described.

First, the CPU 21 calculates a first orthogonal length for each first object identified in step S20. As shown in FIG. 2, the first orthogonal length is a horizontal width WA of the detection frame of the first object to be a target. That is, the first orthogonal length is a length in a direction orthogonal to the specific direction. Similarly, as shown in FIG. 3, the CPU 21 calculates the horizontal width WB of the detection frame of each second object identified in step S20 as the second orthogonal length. After calculating the second orthogonal length for each second object, the CPU 21 determines whether there is a duplicate object. The CPU 21 treats the second object having the same second orthogonal length as a duplicate object instead of targeting the second specific length in step S40. When there is a duplicate object having the same second orthogonal length, the CPU 21 deduplicates the second orthogonal lengths of the duplicate objects stored in the memory 22. Thereafter, the CPU 21 calculates the value of the second specific variable for all combinations of the plurality of first orthogonal lengths and the plurality of second orthogonal lengths held in the memory 22. The second specific variable is obtained by dividing the one second orthogonal length by the one first orthogonal length. The second specific variable is a variable indicating a ratio between one first orthogonal length and one second orthogonal length. Hereinafter, the value of the second specific variable is referred to as a horizontal index value N. When the horizontal index values N are calculated for all the combinations, the CPU 21 calculates the most frequently occurring value among the horizontal index values N as a horizontal mode NQ. The horizontal mode NQ is a value indicating a scaling ratio for the horizontal width of the second image with respect to the first image. After calculating the horizontal mode NQ, the CPU 21 advances the process to step S80. When the plurality of horizontal index values N are all different values, the CPU 21 cancels the calculation of the horizontal mode NQ. In this case, the CPU 21 ends the series of processes of the image comparison process.

When the process proceeds to step S80, the CPU 21 creates a modified image obtained by scaling the first image. The CPU 21 enlarges or reduces the vertical width of the first image in accordance with the vertical mode MQ calculated in step S60. That is, when the most frequent vertical value MQ is larger than 1.0, the CPU 21 enlarges the vertical width of the first image in accordance with the most frequent vertical value MQ. When the vertical mode MQ is smaller than 1.0, the CPU 21 reduces the vertical width of the first image in accordance with the vertical mode MQ. Similarly to the vertical width of the first image, the CPU 21 enlarges or reduces the horizontal width of the first image in accordance with the horizontal mode NQ. In this way, the CPU 21 creates a modified image based on the vertical mode MQ and the horizontal mode NQ. After creating the modified image, the CPU 21 advances the process to step S90.

In step S90, the CPU 21 compares the modified image with the second image. Then, the CPU 21 discriminates between an object that exists in common in the modified image and the second image and an object that does not exist in common. That is, the CPU 21 detects a difference between the modified image and the second image. For example, when the first image shown in FIG. 2 and the second image shown in FIG. 3 are to be compared with each other, the CPU 21 determines an object in a region surrounded by a two dot chain line shown in FIG. 3 as a common object, and determines an object outside the region as a difference object. As shown in FIG. 5, when the CPU 21 detects a difference between the modified image and the second image, the CPU 21 advances the process to step S100.

In step S100, the CPU 21 creates display information indicating the comparison result in step S90. The CPU 21 outputs the created display information to the display device 30. Upon receiving the display information, the display device 30 displays the specific video corresponding to the display information on the display screen 31. The specific video is, for example, the following video. In the specific video, the first image and the second image are displayed side by side, and a differential object is displayed so as to be distinguished from the other objects by brightness or the like. In the specific video, with respect to a common object existing in the first image and the second image, an individual mark is attached to each object forming a pair. In the specific video, the vertical mode MQ calculated in step S60 and the horizontal mode NQ calculated in step S70 are displayed. In the specific video, various kinds of guide information such as what the vertical mode MQ and the horizontal mode NQ indicate are displayed. The display information includes information necessary for displaying such a specific image. That is, the display information includes information on the difference between the modified image and the second image, the vertical mode MQ, the horizontal mode NQ, and the like. After displaying the specific video on the display screen 31, the CPU 21 ends the series of processes of the image comparison process.

### Operation of Embodiment

In the example shown in FIG. 3, the second image is obtained by enlarging the first image shown in FIG. 2 and adding a new object thereto. In this case, combinations of a plurality of first specific lengths and a plurality of second specific lengths for calculating the vertical index value M in step S50 can be roughly classified into three patterns as shown in FIG. 6. The first pattern is a combination of objects originally present in the first image, and is a combination of the same objects. For example, it is a combination of the first object 1 and the second object 1. The second pattern is a combination of objects originally present in the first image, and is a combination of objects different from each other. For example, it is a combination of the first object 1 and the second object 2. The third pattern is a combination of an object originally present in the first image and an object newly added to the second image. For example, it is a combination of the first object 1 and the second object 5A.

The vertical index values M of the above three patterns are as follows. As shown in FIG. 6, the vertical index values M of the sets corresponding to the first pattern are all the same value M1 corresponding to the enlargement ratio of the second image to the first image. On the other hand, the vertical index values M of the sets corresponding to the second pattern are highly likely to be different values. The vertical index values M of the sets corresponding to the third pattern are also likely to be different values. Because of these characteristics, when the vertical index value M is calculated for all combinations, the following can be said about the appearance frequency of the vertical index value M. In other words, the same value M1 appears as many times as the number of sets corresponding to the first pattern, that is, as many times as the number of first objects originally present in the first image. In the example of FIG. 6, three identical values M1 appear corresponding to the three first objects 1 to 3. On the other hand, since random values are calculated for the sets corresponding to the second pattern and the third pattern, the probability that the appearance frequency of a specific value will increase is low. As a result, the mode of the vertical index values M becomes M1 of the first pattern. The mode M1 represents the enlargement ratio of the vertical width of the first object originally present in the first image in the second image, that is, the enlargement ratio of the vertical width of the second image with respect to the first image. Although the meaning of the vertical mode MQ has been described above, the same applies to the horizontal mode NQ. That is, the horizontal mode NQ represents an enlargement ratio of the horizontal width of the second image to the horizontal width of the first image.

### Advantages of Embodiment

(1) As described in the above operation, in the image comparison process, in a case where an object obtained by scaling the first image is included in the second image, many of the same vertical index values M and the same horizontal index values N are obtained. The CPU 21 calculates these values as values indicating the scaling ratio of the second image to the first image. Accordingly, the CPU 21 can accurately calculate the scaling ratio when it is assumed that the scaled first image is included in the second image. The CPU 21 compares the resized first image with the second image based on the scaling ratio. As a result, the CPU 21 can accurately distinguish between an object that is commonly present in the first image and the second image and an object that is not present in the first image and the second image. Since the display screen 31 displays the information of the comparison result, the user can easily determine whether or not the object obtained by scaling the first image is included in the second image, and whether or not a new object is added to the second image. In the image comparison process, the scaling ratio of the second image to the first image can be obtained by a simple method of calculating the modes of the vertical index value M and the horizontal index value N. Therefore, an error or the like hardly occurs in the calculation process, and the scaling ratio of the second image to the first image and the comparison result between the first image and the second image can be accurately obtained.

(2) In step S40 of the image comparison process, the second specific lengths of the duplicate objects are deduplicated. As a result, the following effects can be obtained. The second specific length of the duplicate object is referred to as a duplicate length. In a case where there are duplicate objects, if the duplicate lengths are not deduplicated, the following problem may occur. That is, when the vertical index values M of all combinations of the plurality of first specific lengths and the plurality of second specific lengths are calculated in step S50, if there are a large number of the same duplicate lengths, the number of times the same duplicate length is combined with one certain first specific length increases. For example, if there are four duplicate objects 5A to 5D as in the example of FIG. 3, there are correspondingly four identical duplicate lengths. Consider combining these four identical duplicate lengths with the first specific length of the first object 1 of FIG. 2, for example. In this case, the same duplicate length is combined with the first specific length of the first object 1 four times. Therefore, the appearance frequency of the vertical index value M corresponding to this combination increases. This vertical index value M may become the vertical mode MQ. As a result, a value that is not the vertical index value M corresponding to the scaling ratio that is originally desired to be obtained may become the vertical mode MQ.

A vertical index value M obtained by a combination of a certain first specific length and a certain duplicate length is referred to as a duplicate value. If only one duplicate length stored in the memory 22 is left and the other duplicate lengths are deleted as in the above configuration, the duplicate value is calculated only once. Therefore, it is possible to prevent the duplicate value from becoming the vertical mode MQ. That is, in the configuration described above, it is possible to prevent an erroneous value from being calculated as the vertical mode MQ due to the presence of the duplicate object. Although the vertical mode MQ has been described above as an example, the same applies to the horizontal mode NQ.

(3) In the image comparison process, both of the vertical mode MQ and the horizontal mode NQ are calculated. By changing the size of the first image using both of these values, the first image can be scaled to an appropriate size in both the vertical and horizontal directions. Accordingly, the comparison result between the first image and the second image becomes accurate.

### Modifications

The above-described embodiment may be modified as follows. The above-described embodiment and the following modifications can be combined if the combined modifications remain technically consistent with each other.

The first specific variable is not limited to the example of the above embodiment. The first specific variable may be a variable indicating a ratio between one first specific length and one second specific length. For example, the first specific variable may be obtained by multiplying the first specific variable in the above embodiment by a predetermined coefficient. The method of creating the modified image may be changed in accordance with the content of the first specific variable.

Similarly to the above-described modification example of the first specific variable, the second specific variable is not limited to the example of the above-described embodiment. The second specific variable may be a variable indicating a ratio between one first orthogonal length and one second orthogonal length.

In the above-described embodiment, the value indicating the scaling ratio of the second image with respect to the first image is calculated for the two directions of the vertical and horizontal directions. However, the value indicating the scaling ratio may be calculated for only one direction, or may be calculated for three or more directions. The CPU 21 may calculate a value indicating the scaling ratio for at least one direction set as the specific direction.

The specific direction is not limited to the example of the above embodiment. For example, the specific direction may be set to a direction that intersects both the X-axis and the Y axis of the image coordinate system. As the specific length, the length of the diagonal line of the detection frame may be calculated. The specific direction may be set to a direction appropriate for calculating the value indicating the scaling ratio.

In determining the specific direction, an axis other than the axis of the image coordinate system may be used as a reference. For example, the specific direction may be determined with reference to the upper, lower, left, and right directions on the display screen 31, such as the upward direction on the display screen 31. At this time, the user may designate a specific direction. The orientation of the image with respect to the specific direction may be freely changed by rotating the image on the display screen 31.

The image may be data having three dimensional information of length, width, and depth. In this case, a coordinate system having three coordinate axes orthogonal to each other may be used as a reference. The value indicating the scaling ratio may be calculated for each of the three directions of the vertical direction, the horizontal direction, and the depth direction.

The image may include, for example, a table or a graph. Even in such a case, for example, if the characters of the legend included in the table are handled as objects, the value indicating the scaling ratio can be calculated in the same manner as in the above-described embodiment.

The detection frame is not limited to the example of the above embodiment. The detection frame may be, for example, circular. In this case, the detection frame may be a frame of a minimum circle including the entire object to be detected. The detection frame may be defined as a frame that can include an object to be detected.

The method of identifying an object is not limited to the example of the embodiment described above. The identification method is not limited as long as the object can be appropriately detected. In identifying the object, it is not essential to use the detection frame. After the object itself is identified, the length of the object in a specific direction may be calculated.

It is not essential to deduplicate the second specific lengths of the duplicate objects. Even when this step is eliminated, it is possible to obtain a value indicating the scaling ratio with a certain degree of accuracy.

The manner of displaying each object in the specific video is not limited to the example of the above embodiment. For example, the difference object may be surrounded by a frame. In the specific video, the object of the difference and the object commonly present in the first image and the second image may be distinguishably displayed.

It is not essential to include the information of the difference between the modified image and the second image in the display information output by the CPU 21 to the display device 30. Furthermore, it is not essential for the CPU 21 to detect the difference between the modified image and the second image. Even in this case, the display information output by the CPU 21 to the display device 30 may include a value indicating the scaling ratio of the second image to the first image. Thereby, the following is possible. That is, the user can grasp the value indicating the scaling ratio from the display information output to the display device 30. If the scaling ratio can be grasped, the user can appropriately compare the first image and the second image based on the information, and can easily determine whether or not the object obtained by scaling the first image is included in the second image.

Instead of outputting the value indicating the scaling ratio of the second image to the first image to the display device 30, the control module 20 may output the value indicating the scaling ratio between processing circuits included in the control module 20. For example, the control module 20 may include a first circuit and a second circuit. The first circuit is a dedicated processing circuitry for calculating a value indicating a scaling ratio. The second circuit is a dedicated processing circuitry that compares the first image and the second image using the value indicating the scaling ratio. For example, the second circuit calculates a comparison result obtained by comparing the second image with a modified image obtained by changing the size of the first image by the scaling ratio. In such a configuration, when the first circuit calculates the value indicating the scaling ratio, the first circuit outputs the value to the second circuit. When the second circuit calculates a comparison result obtained by comparing the modified image with the second image, the second circuit outputs information indicating the comparison result to the display device 30. With such a configuration, the user can easily determine whether or not the object obtained by scaling the first image is included in the second image.

The value indicating the scaling ratio may be calculated for only a partial region of each of the first image and the second image.

Images to be compared in the image comparison process are not limited to those intended for insertion into a legal document. The image may for example, be intended for insertion into an instruction manual or specification for a product. The image may not be intended for insertion into a document.

The control module 20 is not limited to a device that includes a CPU and a ROM and executes software processing. That is, the control module 20 may be modified if it has any one of the following configurations (a) to (c).

(a) The control module 20 includes one or more processors that execute various processes according to computer programs. The processor includes a CPU and a memory such as RAM and ROM. The memory stores program codes or instructions configured to cause the CPU to execute processes. The memory, which is a computer-readable medium, includes any type of media that are accessible by general-purpose computers and dedicated computers.

(b) The control module 20 includes one or more dedicated hardware circuits that execute various processes. The dedicated hardware circuits include, for example, an application specific integrated circuit (ASIC) and a field programmable gate array (FPGA).

(c) The control module 20 includes one or more processors that execute part of various processes according to programs and one or more dedicated hardware circuits that execute the remaining processes.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. An image comparison device, comprising processing circuitry, the processing circuitry being configured to:
obtain a first image;
obtain a second image, the second image being different from the first image;
identify multiple first objects in the first image;
identify multiple second objects in the second image;
calculate a first specific length for each of the first objects, the first specific length being a length in a predetermined specific direction;
calculate a second specific length for each of the second objects, the second specific length being a length in the specific direction;
calculate values of a specific variable for all combinations of the first specific lengths and the second specific lengths, each value of the specific variable indicating a ratio between one of the first specific lengths and one of the second specific lengths; and
output a most frequently occurring value among the values of the specific variable as a value indicating a scaling ratio of the second image to the first image.

2. The image comparison device according to claim 1, wherein
two or more of the second objects that have the same second specific length are duplicate objects, and
the processing circuitry is configured to, when there are two or more of the duplicate objects, which have the same second specific length, retain one of the second specific lengths of the duplicate objects and deleting the others, and then calculate values of the specific variable for all combinations of the first specific lengths and the second specific lengths.

3. The image comparison device according to claim 1, wherein
the specific variable is a first specific variable, and
the processing circuitry is configured to:
calculate a first orthogonal length for each of the first objects, the first orthogonal length being a length in a direction orthogonal to the specific direction;
calculate a second orthogonal length for each of the second objects, the second orthogonal length being a length in a direction orthogonal to the specific direction;
calculate values of a second specific variable for all combinations of the first orthogonal lengths and the second orthogonal lengths, each value of the second specific variable indicating a ratio between one of the first orthogonal lengths and one of the second orthogonal lengths; and
output a most frequently occurring value among the values of the second specific variable as a value indicating a scaling ratio of the second image to the first image.

4. The image comparison device according to claim 1, wherein the processing circuitry is configured to:
create a modified image by scaling the first image based on the value indicating the scaling ratio; and
detect a difference between the modified image and the second image by comparing the modified image and the second image.
